(19) United States
(12) Patent Application Publication
(10) Pub. No.: US 2014/0065273 A1
(43) Pub. Date: Mar. 6, 2014

(54) BAKEABLE TRAY AND METHOD OF PREPARING BAKERY ITEMS USING SUCH A BAKEABLE TRAY

(71) Applicant: Calvin S. Krupa, Greenfield, MN (US)

(72) Inventor: Calvin S. Krupa, Greenfield, MN (US)

(73) Assignee: Ultra Green Inc., Plymouth, MN (US)

(21) Appl. No.: 13/599,011

(22) Filed: Aug. 30, 2012

(51) Int. Cl. A47J 37/01; A23L 1/01

(52) U.S. Cl. 426/393; 99/447; 426/392

(57) ABSTRACT

A bakery tray made of an all-natural fibrous material is disclosed to store, ship, bake, and display single-serve baked goods such as muffins and cupcakes. The tray has a plurality of cups and a top plate for serving the cups in position relative to each other. The tray also includes various structures to provide uniform baking of baked goods in either a convention or microwave oven.

### CROSS-REFERENCED TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

I. Field of the Invention

The present invention relates to the production of single-serve bakery items, such as muffins, cupcakes and the like, baked from batter, dough or other bakery mixes. More specifically, the present invention relates to a disposable baking tray which is both bakeable and microwavable and the use of such a tray to prepare and transport bakery products.

II. The Related Art

Commercial bakeries are prevalent throughout the United States. Such bakeries usually offer for sale a number of single-serve baked products such as muffins or cupcakes. The process employed to bake such products typically involves start-to-finish production at the bakery using a number of different containers including measuring cups, mixing bowls, metal baking pans, display trays, and containers used by the ultimate consumer. The process often takes a substantial amount of time for set-up, mixing, baking, displaying, and shipping the baked goods.

In recent years, commercial bakeries and other retail outlets which sell bakery items have sought to reduce the time and expense required to provide consumers with fresh baked goods of consistent quality by procuring and using pre-mixed batter, dough or the like provided by a food supply company. Such bakery mixes are typically shipped from the food supply company to bakeries or other retail establishments in non-biodegradable plastic tubs, bags or the like. The batter, dough or other bakery mix is then transferred to metal bakery pans for baking at the bakery or other retail establishment. While the use of such a bakery mix reduces the time the bakery or other retail establishment must expend mixing and cleaning the containers and utensils used during the mixing process, this technique does lead to substantial waste of batter or dough and the need to recycle or dispose of the containers in which the batter or dough is shipped. It also does not eliminate the need for clean baking trays and containers used to display and transport the baked goods.

Various attempts have been made to solve the problems described above by depositing a bakery mix in a non-metal biodegradable tray, freezing the bakery mix, and then shipping the frozen bakery mix to a bakery where it is then baked. As noted in U.S. Pat. No. 6,869,059 granted on Mar. 22, 2005 to Sloan et al entitled “Bakeable Muffin Pan, and Use Thereof”, some have even tried to bake the bakery goods in the trays in which the frozen bakery mix was shipped. This, however, has met with limited success because such trays are non-conductive resulting in hot and cold spots and uneven baking. As discussed by Sloan et al, muffins at the perimeter of the pan cooked more quickly than muffins at the center of the pan. Sloan et al attempted to address these problems by providing a pan made of a polymeric material, a thermoplastic material, a metal foil material, or a combination of paper and a food-contact liner made of polyester or an acrylic material. The pans disclosed by Sloan et al include a perimeter wall extending above the main surface of the pan, above the level of batter or dough in the pan, and above the top of the final baked product in the pan. The wall forms a shield or baffle which, according to Sloan et al, provides more consistent heat to the batter or dough than if no wall was present.

The use of the material described by Sloan et al creates certain complications related to the manufacture and disposal of the pan. The presence of the wall raises the material costs related to the manufacture of the pan and the efficacy of the wall also will depend on the nature and location of the heating elements in the oven, the shape of the oven cavity, the positioning of the tray within the oven cavity and the number of baking cups provided by the pan.

### SUMMARY OF THE INVENTION

All of the foregoing problems are resolved by applicant's invention. Applicant provides a disposable baking tray comprising a body made from all-natural materials. The tray is bakeable, microwavable, and biodegradable. A plurality of cups is formed in the body. Each cup has an open top surrounded by an outer rim and a containment surface comprising a bottom and a wall extending between the outer rim and the bottom. The outer rim surrounding the open top may be raised. A top plate is also formed in the body. The top plate has a top surface, a bottom surface, and an outer edge. The top plate is integrally formed and extends between the cups joining the cups together while holding the walls of the cups away from each other. The top surface of the top plate is positioned below the top of the raised outer rim of each cup when such a raised outer rim is provided. The tray also includes a plurality of heat transfer passages. Some of the heat transfer passages comprise recesses in the outer edge of the top plate between each pair of adjacent cups bordering the outer edge. Others include holes through the bottom of each of the cups. Others include elongate slots in the walls of the cups. Still others include apertures through the top plate between the cups. The top plate may also include a plurality of dimples to assist in denesting a tray from a stack of trays.

Batter, dough or some other bakery mix can be prepared and deposited in each cup of the tray at a first location. The tray can then be covered and shipped to a second location either with or without first freezing the bakery mix. At the second location, the tray can be uncovered and placed in an oven to thaw and bake the food. The tray can then be employed to display the baked goods and even to transport the goods after baking. The use of such a tray in this fashion is environmentally sound because the tray is made of all-natural fibers derived from plant material which are recyclable and biodegradable. The use of such trays also eliminates the need to clean and sanitize multiple containers used to transport, bake and display the baked goods because all of these steps are carried out using the same tray. Other advantages arising from the use of such trays and the details of construction of such trays will become clearer from the detailed description provided below in view of the accompanying drawings.

### BRIEF DESCRIPTION OF THE DRAWINGS

FIG. 1 is a perspective view showing a tray for muffins, cupcakes or other single-serve bakery items.

FIG. 2 is a top plan view of the tray shown in FIG. 1.

FIG. 3 is a bottom plan view of the tray shown in FIG. 1.

FIG. 4 is an end view of the tray shown in FIG. 1.

FIG. 5 is a side view of the tray shown in FIG. 1.

FIG. 6 is a top plan view of an alternate tray.

FIG. 7 is an end view showing slots which may be provided in the walls of the cups.

FIG. 8 is a schematic diagram of a tray like those shown in FIGS. 1-7 together with a top cover.

FIG. 9 is a schematic diagram of the tray and cover shown in FIG. 8 attached to each other.

FIG. 10 is a flow chart showing a process employing the tray shown in FIGS. 1-9.

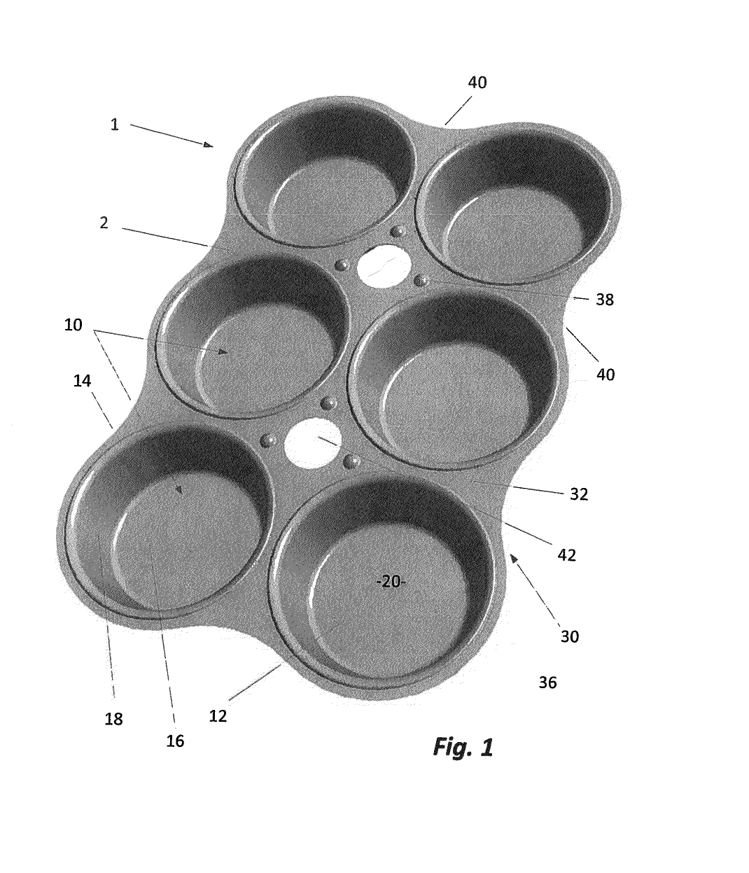

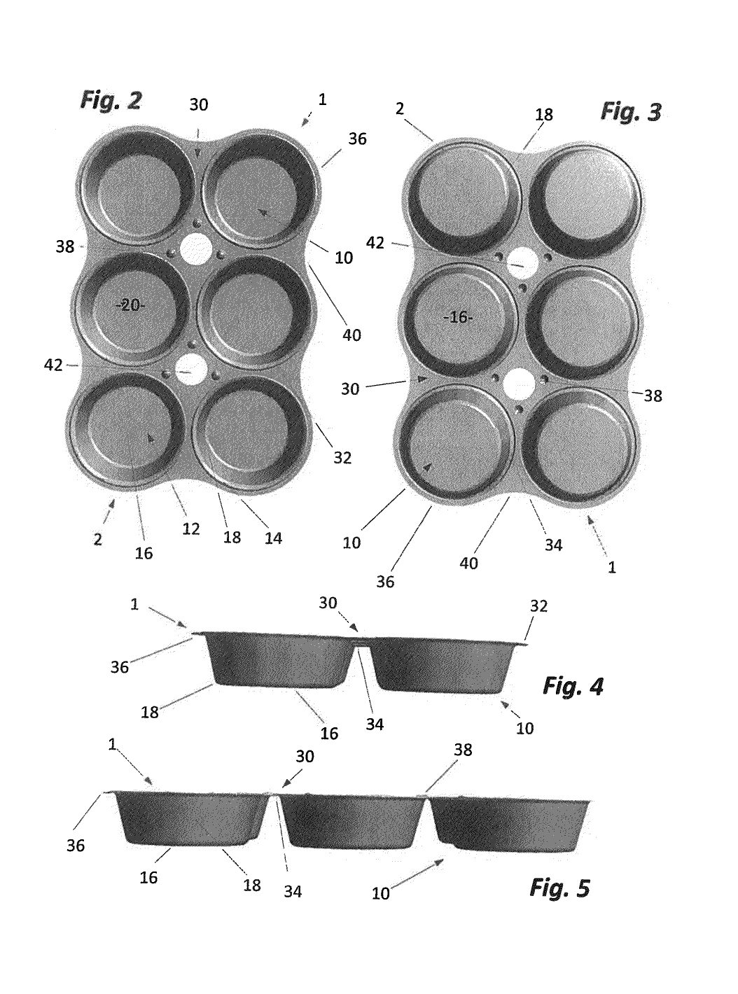

### DETAILED DESCRIPTION

The trays 1 shown in each of the drawings are preferably an integrally formed body 2 made from one or more all-natural fibrous materials. Suitable all-natural fibrous materials can be formed from fibrous plants such as bamboo, wheat straw or bagasse. Other plants may also serve as the source of fibrous plant material. Also, recycled paper may serve as the source of fibrous plant material since paper is typically made of such fibrous plant material.

The material employed is bakeable, i.e., it may be subjected to oven temperatures of at least about 450° F. without damage to the body 2 of the tray 1. The material is also microwaveable, i.e., the material is microwave transmissive such that the material will not materially shield the food from microwave energy and the material also is not susceptible to arcing or sparking when subjected to microwave energy. Any microwave energy absorbed by the tray will heat the tray and assist with baking.

Tray 1 includes a plurality of cups 10 formed in the body 2. While six such cups 10 are shown in the drawings, a lesser number of cups 10 or a greater number of cups 10 may be employed without deviating from the invention. Typically, the cups 10 will be arranged in rows and columns as illustrated in the drawings.

Each cup 10 has an open top 12 surrounded by an outer rim 14 which may be raised as illustrated. Each cup 10 also has a containment surface comprising a bottom 16 and a wall 18 which extends between the outer rim 14 and the bottom 16. As such, each cup 10 forms a separate baking chamber 20 accessible through the open top 12.

Tray 1 also includes a top plate 30 formed in the body 2. The top plate 30 has a top surface 32, a bottom surface 34, and an outer edge 36. The top plate 30 is integrally formed with and extends between the cups 10. The top plate 30 serves to join the cups 10 together while holding the walls 18 of the cups 10 away from each other. The top surface 32 of the top plate 30 is positioned at or below the top of the outer rims 14 of each of the cups 10. The top plate 30 also has a plurality of dimples 38 which assist when denesting a tray 1 from a stack of such trays 1.

Formed in the tray 1 is a plurality of heat transfer passages. Such heat transfer passages include recesses 40 formed in the outer edge 36 of the top plate 30. As shown, a recess 40 is formed between each pair of adjacent cups 10 bordering the outer edge 36 of the top plate 30. The number of recesses 40 will depend on the number of cups 10 bordering the outer edge 36 because such a recess 40 should be formed between each such pair of cups.

Such heat transfer passages also include apertures 42 formed through the top plate 30. The apertures 42 are located in the portions of the top plate extending between four cups 10. The number of apertures 42 will depend upon the number and arrangement of cups 10 because an aperture 42 should be formed in each portion of the top plate 30 extending between more than two cups. In the drawings, apertures 42 are formed in the spaces extending between four cups 10. By way of example, if the body 2 of tray 1 included four cups 10 arranged in two rows, one aperture 42 would be provided. Likewise, if the body 2 of tray 1 included two rows of four cups, three such apertures 42 would be provided. If the body 2 of tray 1 included nine cups 10 arranged in three rows of three cups 10, four such apertures 42 would be provided.

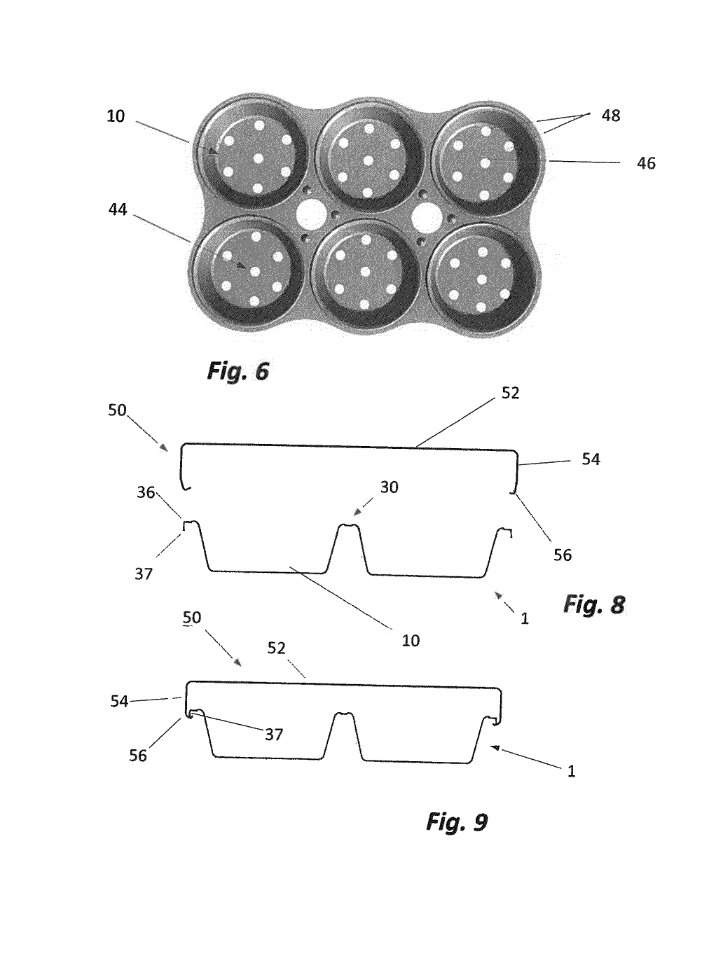

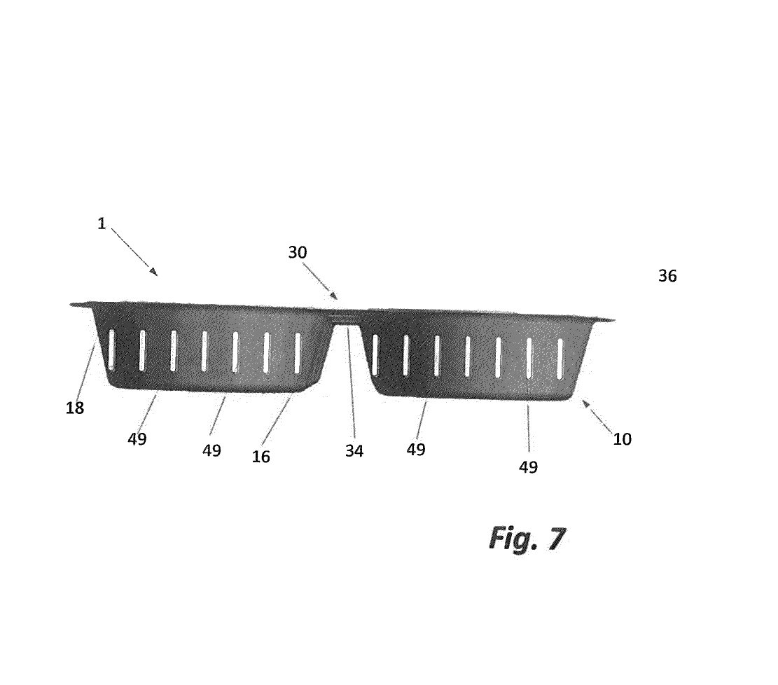

FIGS. 6 and 7 each show an additional type of heat transfer passage. As shown in FIG. 6, a plurality of holes 44 extends through the bottom 16 of each cup 10. The plurality of holes 44 includes a center hole 46 and six outer holes 48 spaced about hole 46. As shown in FIG. 7, the heat transfer passages may also include a plurality of elongate slotted openings 49 in the wall 18 of each cup 10. The number and dimensions of the slotted openings 49 will depend on the size of the cups 10. Slots approximately ⅛ inch wide and approximately 1% inches long provide effective heat transfer for a cup 10 of a typical size for baking muffins and cupcakes. The holes 44, slotted openings 49, and the open top 12 of the cups 10 not only permit heat transfer, but also permit moisture to escape from the cup during baking. Openings through the containment surface of various shapes, arrangements, and sizes other than those of the holes 44 and slotted openings 49 may be employed without deviating from the invention.

Thus, the tray 1 may include at least four separate types of heat transfer passages—(1) the recesses 40 formed in the outer edge 36 of the top plate 40 between each pair of cups 10 bordering the outer edge 36; (2) the apertures 42 formed in each portion of the top plate 30 extending between four cups 10; (3) the holes 44 through the bottom 16 of each cup 10; and (4) the slotted openings 49 through the walls 18 of the cups 10. The presence of these heat transfer passages provide relatively uniform heating of food deposited in the cups when placed in a conventional or microwave oven.

Uniform heating is further assisted by the spacing between and shape of the cups 10. As illustrated, the wall 18 of each cup has a frusto-conical shape. The angle between the bottom 16 and the wall 18 of each cup 10 is approximately 104°. In other words, the outer draft of the walls 18 of the cups 10 is about 14° from vertical (104°−90°=14°). The spacing between the outer rims of adjacent cups 10 in a row or column is preferably approximately ¼ inch or greater. The angle between the walls 18 of such adjacent cups 10 is approximately 28°. The outer rim 14 of each cup 10 extends above the top surface 32 of the top plate 30 by about at least 1/16 of an inch.

The thickness of the walls 18 and bottoms 16 of the cups 10, the size of each cup 10 and size of the open top 12 of each cup 10 also assist to provide uniform heating. Trays 1 having cups 10 of different sizes may be provided to bake treats of different sizes. The thickness of the bottom 16 and wall 18 are each about 0.024 inches. The diameter of the bottom of the cup is about 3.2 inches and the outside diameter of the top of each cup (from the outside of the raised rim) is about 4.5 inches. While it is possible to change the foregoing angles and dimensions and still achieve heating uniformity adequate for baking, the angles and dimensions recited above have been found to yield sufficient heating uniformity.

When openings are provided through the containment surface such as the holes 44 are provided through the bottom 16 or the elongate slotted openings 49 through the wall 18 of a cup 10, a cup liner (not shown) may be employed to prevent bakery mix (e.g., batter or dough) from exiting the cup 10 through such openings. Such cup liners are well-known in the art and are commonly used with metal muffin pans to prevent food from adhering to the muffin pan. Preferably, the cup liners employed will be made of an all-natural, biodegradable, bakeable and microwavable material. Such cup liners will also be thin-walled and, perhaps, corrugated to promote uniform heating of the food placed in the cup liner.

In certain situations it will, of course, be advantageous to cover the tray 1 and the goods to be, or which have been, baked therein as illustrated in FIGS. 7 and 8. A cover 50 is shown. The cover 50 has a top 52, a side wall 54 and a flange 56. The shape of the top 52, side wall 54, and flange 56 should conform to the shape of the tray to permit the tray 1 and cover 50 to be coupled together.

To couple the tray 1 and cover 50 together, the outer edge 36 of the top plate 30 of the tray 1 may be provided with a continuous downwardly projecting lip 37 or with a plurality of lips 37 positioned along the outer edge 36. The cover 50 may be provided with a single continuous flange 56 or a plurality of flanges. The cover 50 may be joined to the tray 1 as illustrated in FIGS. 7 and 8 by mating the flange(s) 56 on the cover 50 with the lip(s) 37 of the tray 1. For ease of molding, strength and improved latching of the cover 50 to the tray 1, use of a single continuous lip 37 and a single continuous flange 56 is generally preferred. Other arrangements known in the art for coupling a lid to a container may also be employed without deviating from the invention.

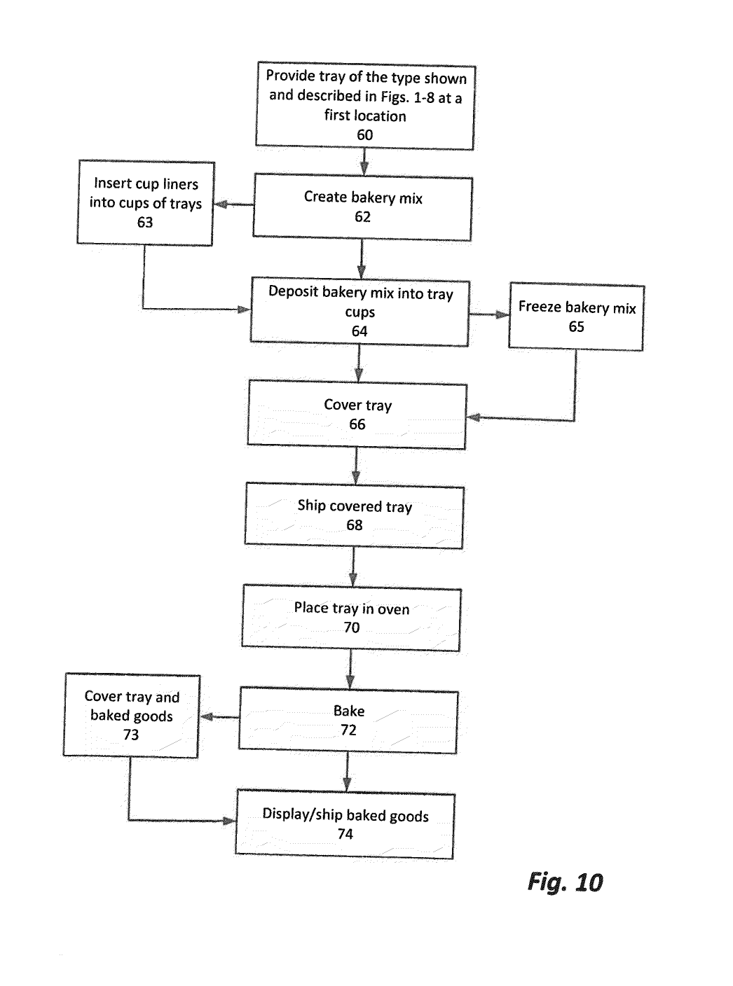

The tray 1 offers various advantages for commercial bakery, restaurant, grocery, convenience store and food distribution operations as illustrated in FIG. 9. By way of example, at a first location (e.g., a food distribution plant) a tray 1 is provided at step 60 and a bakery mix is formulated at step 62. At step 64, a measured amount of a bakery mix is inserted into each cup 10 of the tray 1. Cup liners will typically be placed in the cups 10 before depositing the bakery mix as illustrated at step 63 if the cups 10 have holes 44 or elongate slotted openings 49. The bakery mix may be batter, dough or some other formulation for making muffins, cupcakes, brownies, or the like. The bakery mix may be fresh when inserted or already frozen. If the bakery mix is fresh, it may then be frozen while in the cups 10 as indicated at step 65. The baking tray 1 is then covered at step 66 to prevent contamination of the bakery mix and to prevent bakery mix from exiting the cups 10 of the tray 1. The covered baking tray 1 may then be shipped from a first location to a second location as indicated at step 68.

At the second location (e.g., a commercial bakery, grocery store, convenience store or restaurant) the covering may be removed from the tray 1. The tray 1 and bakery mix in the cups 10 may then be placed in a standard oven or microwave oven as illustrated at step 70 and subjected to sufficient energy to thaw and/or bake the bakery mix as illustrated at step 72. The tray 1 can then be used to hold the baked goods during cooling, storage, sales display, transportation, and even serving of the baked goods as indicated at step 74. A cover such as cover 50 may be employed as indicated at step 73 to prevent contamination and to retain the baked goods within the cups 10 of the tray during step 74.

The present invention is not limited to the specific embodiments of the invention described above. The invention is only limited to the subject matter defined by the following claims together with a full range of the equivalents.

What is claimed is:

1. A disposable baking tray comprising:
a. a body made from all-natural fibers, said body being bakeable and microwavable;
b. a plurality of cups formed in the body, each cup having an open top surrounded by an outer rim and a containment surface comprising a bottom and a wall extending between the rim and the bottom,
c. a top plate formed in the body, the top plate having a top surface, a bottom surface and an outer edge, and integrally formed with, extending between and joining the cups together while holding the walls of cups away from each other, the top surface positioned at or below the top of the rim of each cup;
d. a plurality of heat transfer passages, the plurality of heat transfer passages comprising a recess in the outer edge of the top plate between each pair of adjacent cups bordering the outer edge, a plurality of holes through the containment surface of each of the plurality of cups, and at least one aperture formed through the top plate.

2. The disposable baking tray of claim 1 wherein the wall of each cup has a frusto-conical shape.

3. The disposable baking tray of claim 2 wherein the wall of each cup has an outward angle of about 104 degrees when measured from the bottom of the cup.

4. The disposable baking tray of claim 1 wherein said plurality of cups comprises four cups arranged in at least two rows.

5. The disposable baking tray of claim 4 wherein the at least one aperture is formed through the top plate in the portion of the top plate extending between the four cups.

6. The disposable baking tray of claim 1 wherein said plurality of cups comprises at least six cups arranged in at least two rows and wherein two apertures are formed through the top plate, one such aperture in each portion of the top plate extending between four adjacent cups.

7. The disposable tray of claim 1 wherein the plurality of holes through the containment surface of each cup comprises a plurality of holes through the bottom, said plurality of holes consisting of a center hole and a plurality of additional holes surrounding the center hole.

8. The disposable tray of claim 1 wherein the plurality of holes through the containment surface of each cup comprises a plurality of elongate slotted openings through the wall.

9. The disposable tray of claim 1 wherein the all-natural fibers are selected from the group consisting of bamboo, wheat straw and bagasse fibers.

10. The disposable tray of claim 1 wherein the source of all-natural fibers is recycled paper.

11. The disposable tray of claim 1 wherein the outer rim of each cup is raised and extends above the top surface of the top plate by at least 1/16^{th} of an inch.

12. The disposable tray of claim 1 wherein the outer edge of the top plate has a downwardly extending flange.

13. The disposable tray of claim 12 further including a cover including a locking structure which mates with the downwardly extending flange to secure the cover to the body.

14. The baking tray of claim 1 wherein the plurality of holes through the containment surface of each cup includes a plurality of openings in the bottom and a plurality of openings in the wall of each cup.

15. The baking tray of claim 14 wherein the openings in the wall are elongate slotted openings.

16. The baking tray of claim 15 wherein the elongate slotted openings are each approximately ⅛ inch thick and approximately 1% inches wide.

17. The disposable baking tray of claim 1 further comprising a plurality of dimples extending from a surface of the top plate.

18. A method of providing baked goods comprising:
a. a first location, providing a disposable baking tray comprising:
(i) a body made from all-natural fibers, said body being bakeable and microwavable;
(ii) a plurality of cups formed in the body, each cup having an open top surrounded by an outer rim and a containment surface comprising a bottom and a wall extending between the raised outer rim and the bottom;
(iii) a top plate formed in the body, the top plate having a top surface, a bottom surface and an outer edge and integrally formed with and extending between the cups and joining the cups together while holding the walls of cups away from each other, the top surface positioned at or below the top of the raised outer rim of each cup; and
(iv) a plurality of heat transfer passages, the plurality of heat transfer passages comprising a recess in the outer edge of the top plate between each pair of adjacent cups bordering the outer edge, a plurality of holes through the containment surface of each of the plurality of cups, and at least one aperture formed through the top plate;
b. at the first location, inserting bakery mix into each of the cups;
c. at the first location, covering the baking tray to prevent contamination of the bakery mix and to prevent the bakery mix from exiting the cups;
d. shipping the covered baking tray from a first location to a second location; and
e. at the second location, subjecting the bakery mix to energy to bake the bakery mix.

19. The method of claim 18 wherein the bakery mix is inserted into the cups in a frozen form.

20. The method of claim 18 wherein the bakery mix is inserted into the cups and then, while still at the first location, frozen prior to the shipping step.
